(19) United States
(12) Patent Application Publication
(10) Pub. No.: US 2004/0094363 A1
(43) Pub. Date: May 20, 2004

(54) Ladder with rund stabilising device

(76) Inventor: Fred Bagshaw, Dundas (CA)

Correspondence Address: GOWLING, LAFLEUR HENDERSON LLP, SUITE 560, 120 KING STREET WEST, PO BOX 1045, LCD 1, HAMILTON, ON, L8N 3R4, CA

(21) Appl. No.: 10/648,213

(22) Filed: Aug. 27, 2003

Related U.S. Application Data
(60) Provisional application No. 60/406,330, filed on Aug. 28, 2002.

(51) Int. Cl. E06C 1/52

(52) U.S. Cl. 182/196

(57) ABSTRACT

A rope ladder having a plurality of steps, each step having a horizontal support surface and two bores and at least two spaced-apart ropes, each with a stop member fixed to the ropes thereby providing a downward stop for each step.

### FIELD OF THE INVENTION

The present invention relates to rope ladders and a method of securing the steps in position.

### BACKGROUND OF THE INVENTION

Rope ladders have long been used in a variety of different applications. The use of rope ladders to escape through a window when the conventional exit route is blocked was disclosed as long ago as 1865 in U.S. Pat. No. 50,596. The present marketplace provides a variety of ladder products intended as escape ladders. Rope ladders have also been used in various shipboard applications and as rescue ladders in helicopters and the like. More recently, the rope ladders has become a popular piece of playground equipment since learning to climb is an important developmental step. Rope ladders provide a climbing challenge to children as the ladder may move with each step taken.

Rope ladders typically comprise a series of rigid or semi-rigid rungs which are attached at spaced intervals to a pair of ropes.

There are many patents directed to collapsible ladders. For example, U.S. Pat. No. 6,382,352 discloses a Kevlar™ type fire escape ladder with PVC rungs that has a weighted bottom step. U.S. Pat. No. 4,702,347 discloses a folding, burglarproof fire escape ladder. U.S. Pat. No. 4,127,184 discloses a combination plant box and escape ladder.

Several patent have addressed the problem of how to attach the platform or rung to the flexible vertical member. U.S. Pat. No. 4,442,920 discloses a ladder in which rope segments are placed in open-ended notches disposed in the platforms and are then clamped into position. In U.S. Pat. Nos. 4,241,809 and 4,554,996 a pair of wedge collars is used in cooperation with each step. A wedge collar is disposed below each of the through openings bearing up against the step. U.S. Pat. No. 4,683,981 also discloses a generally diamond-shaped wedge heart. U.S. Pat. No. 2,990,908 is directed to the use of a knot placed before and after each rung for proper positioning. This is time consuming and not amenable to mass production.

U.S. Pat. No. 4,475,628 is directed to an embarkation/debarkation net. The net includes securing elements which comprise a pair of perpendicularly crossed tubular elements. The tubular elements may be tubes of heat shrinkable material. The purpose of the tubular elements is to maintain the components of the net in spaced orientation and it requires a cross of elements to be effective.

Another way in which ladder rungs have been held in position is by passing the rope through an opening in the rung and then around and over the outside of the rung where it is stapled in position. This type of configuration can be seen, for example, in the playground rope ladder marketed by Walnut Grove Fence and Playground as the C-26R Heavy Duty Ladder. See www.walnutgrove.com. Potential drawbacks of this method are the cost of extra rope and staples and the time required to position the rungs.

Although rope ladders have been in use for a long time, there remains a need for a ladder that is secure and easy to assemble. The present invention addresses the problems associated with the prior art methods of securely maintaining the rungs in position.

### SUMMARY OF THE INVENTION

The present invention provides a rope ladder in which the rungs can be positioned in place quickly and securely. The ladder is useful in a variety of situations. The flexible ladder of the present invention is particularly useful as a climbing apparatus for a playground.

The ladder is designed so that the rungs resist slippage when downward pressure is applied.

In one aspect of the invention, there is provided a flexible ladder having:

i) a plurality of steps, each step having a horizontal support surface and two bores, one of said bores at each end of said horizontal support surface;

ii) at least two spaced-apart flexible vertical members, each of said flexible spaced-apart members passing through one of said bores in said support surface; and

iii) a stop member encircling each of said flexible vertical members thereby providing a downward stop for each step.

In a preferred embodiment, the stop member is a length of heat-shrinkable tubular sleeving positioned on said flexible vertical member.

In another preferred embodiment, the steps comprise a plurality of platforms, each platform selected from the group consisting of a dowel, a length of plastic, PVC or metal tubing and a wooden or synthetic slat.

In yet another preferred embodiment, the flexible vertical member is a length of flexible material which may comprise a rope, a strap, a cable, a chain or the like.

In another aspect of the invention, a method of assembling a rope ladder is provided. The method comprises threading a rope or other type of flexible member sequentially through a bore in a step and then a heat-shrinkable tube. The steps and the sleeves are held in predetermined spaced positions. The sequential threading is continued until the desired ladder length is achieved. Heat is then applied to shrink the sleeves so that they are held in position on the rope.

In an alternative method of the present invention, the flexible members are held in position vertically and a dowel is positioned over the rope so that the bore of the dowel lines up with the rope and then the dowel slides down the rope to a predetermined position. Next a heat-shrinkable sleeve is slid down the rope until it comes to a rest at the dowel.

### BRIEF DESCRIPTION OF THE DRAWINGS

Preferred embodiments of the invention are described below with reference to the drawings in which:

FIG. 1 illustrates a prior art rope ladder;

FIG. 2 illustrates a first embodiment of the present invention;

FIG. 3 illustrates a second embodiment of the invention;

FIG. 4 illustrates the rung positioning device;

FIG. 5 illustrates one method of production by which the rung positioning device can be positioned on the rope; and

FIG. 6 illustrates another method of making the rope ladder of the present invention.

### DESCRIPTION OF THE PREFERRED EMBODIMENTS

Rope ladders are well known in the art. In the present invention, the term “rope ladder” refers to a flexible ladder having a plurality of platforms suspended by at least two flexible vertical members. The term “flexible vertical member” refers to a rope, a strap, a piece of cable or any other linear flexible material that is disposed vertically when in use. The term “platform” refers to any horizontal support which is used to support a person's weight as they climb the ladder. This may be a rung, a dowel, a slat, a metal or plastic step, a piece of synthetic tubing, a length of rope or the like. The flexible member typically passes through a hole or bore disposed in the platform. The platform is secured in position on the vertical member to form a step or rung.

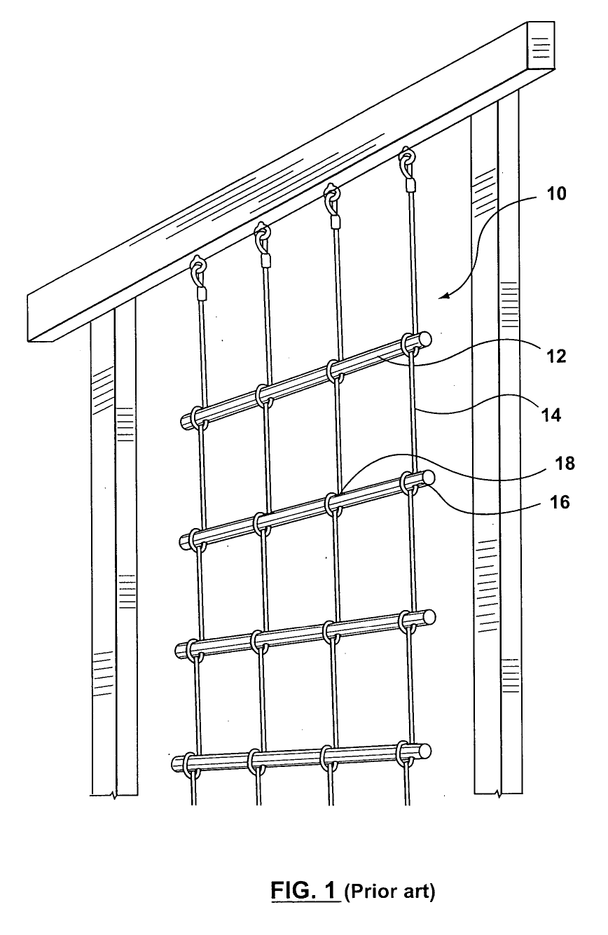

An example of a prior art playground rope ladder is illustrated in FIG. 1. The rope ladder 10 comprises a series of rungs. Each rung 12 is positioned along four nylon ropes 14. Each rung 12 has several bores 16, 18. The rope is threaded through the bores and then wrapped around the rung and stapled to itself to hold the rung in position. The rope is then passed on to the next rung, threaded, wrapped around and so on. This format requires a rope length significantly in excess of the ladder length and staples and also requires substantial hands-on time.

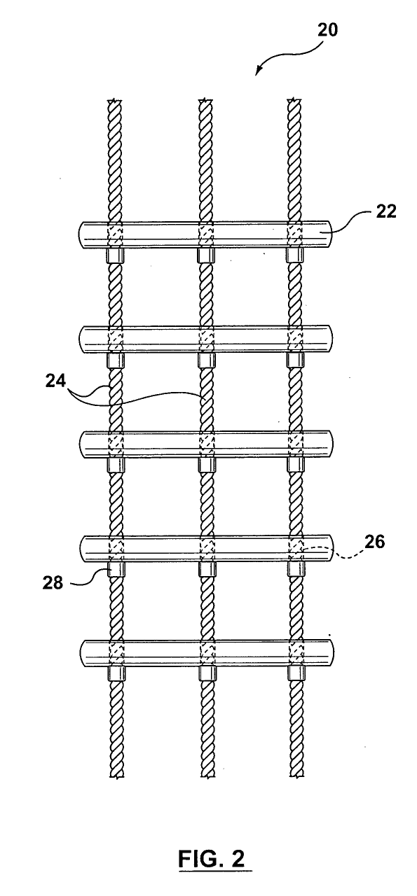

The present invention addresses the problems of the prior art by providing a novel method for holding the rungs of a rope ladder in position. Referring now to FIG. 2, a ladder 20 is provided which comprises a plurality of platforms or horizontal supports 22 positioned along vertical flexible members 24. The flexible vertical members 24 pass through bores 26 in each horizontal support 22. It is clearly apparent that the horizontal supports can be flat as well as round and that a slot may take the place of the bore. While three flexible vertical members are illustrated, the device can also comprise only two or more than three vertical members. The vertical members can be made from any flexible material. Preferred flexible materials include rope, nylon cord, chain, cable, strapping and the like. A stop member 28 is positioned below each horizontal support to prevent the horizontal support from slipping down the vertical member when downward pressure is applied, such as when a person steps on the horizontal support. The use of a stop member eliminates the need to wrap the rope around the dowel.

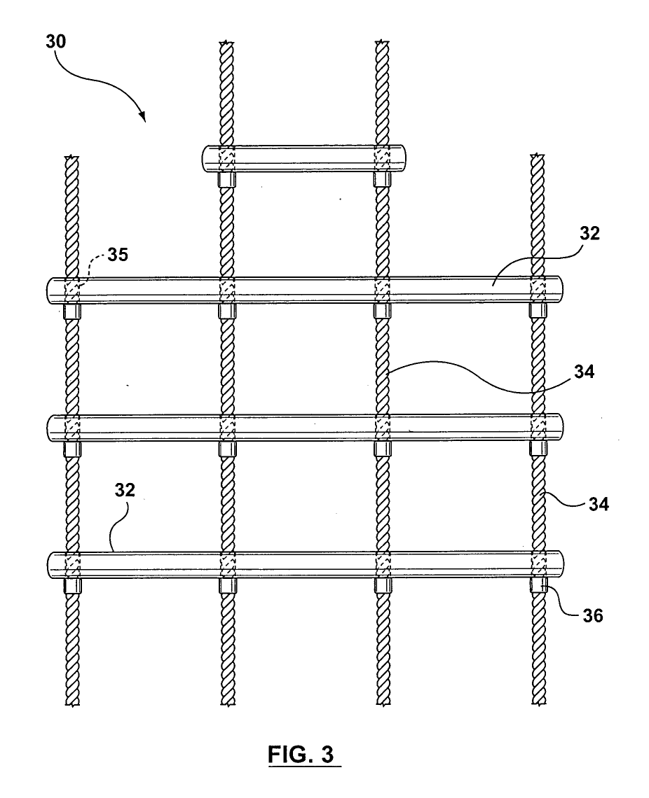

FIG. 3 illustrates another embodiment of the flexible ladder of the present invention. A playground climber 30 is provided in which a lattice of horizontal supports 32 and flexible vertical members 34 are provided. The horizontal supports 32 are typically dowels with a bore 35 at each end and the vertical members are typically ropes. A stop member 36 is positioned below each of the bores 35. The embodiment illustrated in FIG. 3 is particularly useful as a climbing apparatus for a playground. The horizontal supports may be staggered to provide a greater climbing challenge.

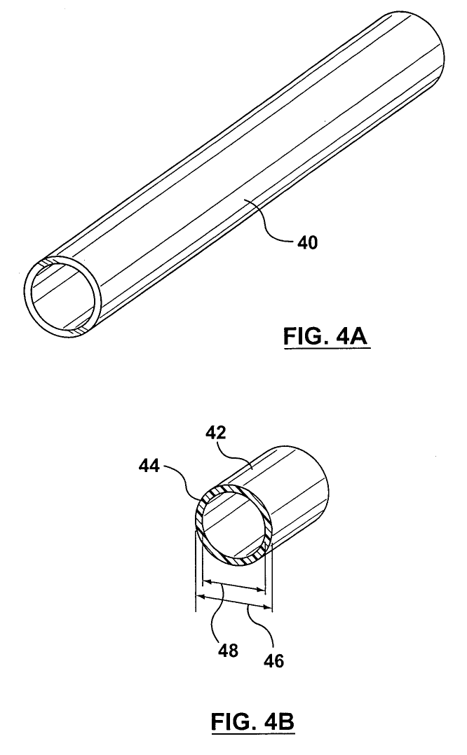

An exemplary stop member is shown in FIGS. 4A and 4B. A heat shrinkable tube 40 is cut into predetermined lengths to provide a number of sleeves 42. Each sleeve 42 is adapted to be threaded onto the flexible vertical member. The interior diameter of the sleeve is large enough to slide over vertical member. The sleeve 42 comprises thermoplastic material 44 which shrinks upon the application of heat. The tubular sleeve 42 shrinks to tightly encapsulate the flexible vertical member. When shrunken, the tubular sleeve has an exterior diameter 46 which is larger than the diameter of a bore in a support platform and an interior diameter 48 which is snug against a flexible vertical member. The length of the sleeve is preferably longer that the diameter. In a preferred embodiment the sleeve is 2-3 mm. thick and approximately 1 inch long. The sleeve is sufficiently tight around the rope to prevent the horizontal platform or step from sliding down when someone steps on it. In the case where the step is a slat, the sleeve is of an adequate diameter to prevent the vertical member from sliding through the slot.

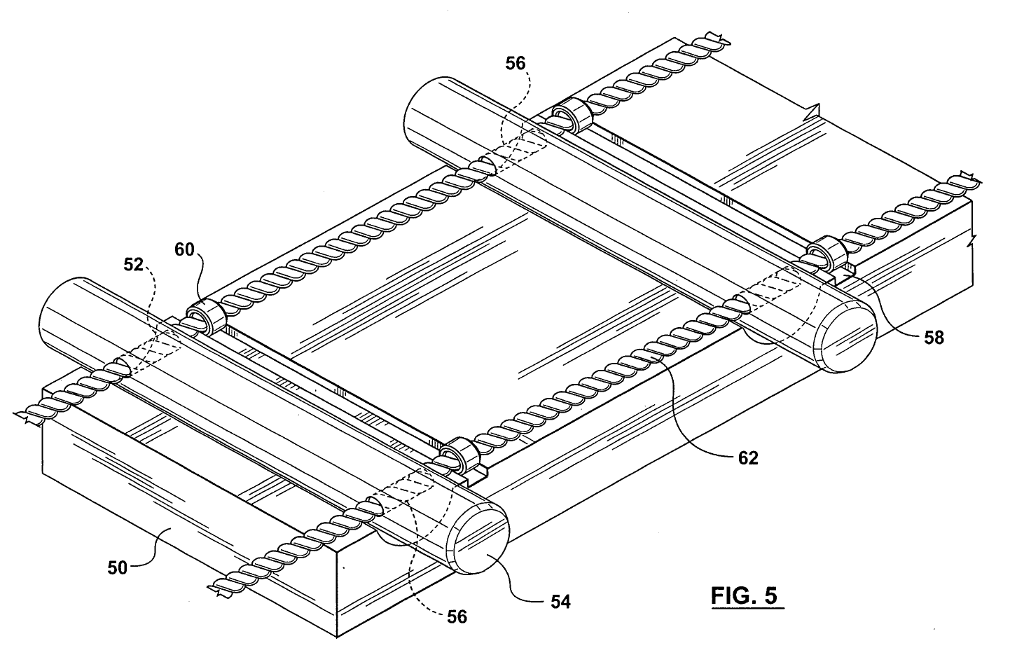

FIG. 5 illustrates one possible method for manufacturing the ladders of the present invention. A base 50 has a series of grooves 52 adapted to hold a dowel 54. The dowel 54 has a bore 56 at each end. The base 50 also includes means 58 for holding thermoplastic sleeves 60. A rope 62 is passed through the center of the sleeve 60 and through the bore 56 in the dowel 54. Once in position, the system is heated and the thermoplastic sleeves 60 tightly encompasses the rope 62. When in use, the heat-shrinkable sleeve 60 prevent the rope 62 from slipping through the bores 56 in the dowel 54. A two sided press type of system where the ladder is held between two heated plates can also be used.

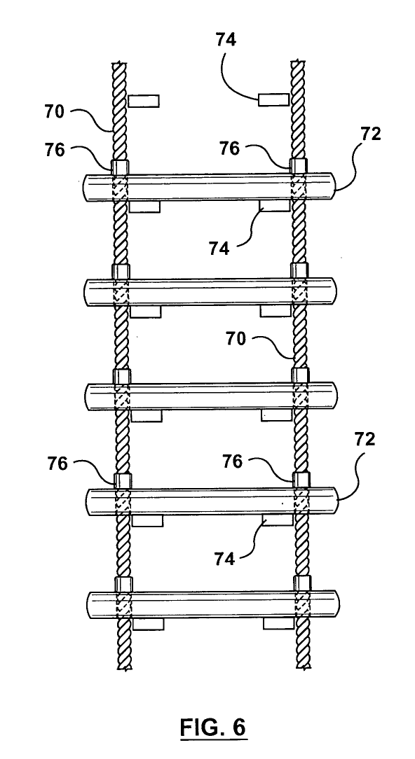

Another way of assembling the ladder is shown in FIG. 6. The vertical members or ropes 70 are held in an upright position. A dowel 72 is slid down the rope and comes to stop against a positioning block 74. The positioning block of the assembly device can be moved in and out of position to stop or not stop the dowel. A thermoplastic sleeve 76 is then slid down the rope and comes to rest against the dowel. The next set of positioning blocks are pivoted into position and the next dowel is slid down the ropes followed by the next thermoplastic sleeve. The process is repeated until the desired length of ladder is achieved. Heat is then applied and the thermoplastic sleeves shrink tightly around the rope.

While specific embodiments have been described herein in detail, it is apparent that the basic construction can be altered to provide other embodiments not specifically described. Thus, changes in construction and applications of the invention will suggest themselves without departing from the spirit and scope of the invention. The disclosures and descriptions herein are purely illustrative and are not intended to be in any sense limiting.

I claim:

1. A flexible ladder comprising at least two spaced flexible vertical members, a plurality of horizontal support platforms, each support platform having an opening at each end adapted to receive one of said vertical members and a stop member encircling each of said flexible vertical members thereby providing a downward stop for each step.

2. A flexible ladder according to claim 1 wherein the stop member is a length of heat-shrinkable tubular sleeving positioned on said flexible vertical member.

3. A flexible ladder according to claim 1 wherein the support platform is selected from the group consisting of a dowel, a length of plastic, PVC or metal tubing and a wooden or synthetic slat.

4. A flexible ladder according to claim 1 wherein the flexible vertical member is selected from the group consisting of a rope, nylon cord, a strap, a cable, a chain and a length of flexible material.

5. A flexible ladder according to claim 1 wherein the horizontal support platform is a wooden dowel and the vertical member is a length of rope.

6. A flexible ladder climbing apparatus for a playground comprising at least three ropes and a plurality of steps held in position on the ropes by a thermoplastic sleeve that is heat shrunk around the rope.

7. A method of assembling a flexible ladder, said method comprising sequentially threading a flexible vertical member through a bore in a step and then a heat-shrinkable tubular sleeve until a desired ladder length is achieved and then applying heat to shrink the sleeve thereby preventing the step from moving on the rope in response to downward pressure.
